(19) United States
(12) Patent Application Publication
(10) Pub. No.: US 2019/0012975 A1
(43) Pub. Date: Jan. 10, 2019

(54) PIXEL CIRCUIT STRUCTURE AND DISPLAY PANEL

(71) Applicants: HKC Corporation Limited, Shenzhen (CN); Chongqing HKC Optoelectronics Technology Corporation Limited, Chongqing (CN)

(72) Inventor: YU-JEN CHEN, Chongqing (CN)

(21) Appl. No.: 15/744,839

(22) PCT Filed: Mar. 14, 2017
(86) PCT No.: PCT/CN2017/076541

§ 371 Date: Jan. 15, 2018

(30) Foreign Application Priority Data
Dec. 30, 2016 (CN) 201611270319.1

(51) Int. Cl. G09G 3/36; G02F 1/1362; G02F 1/1368

(52) U.S. Cl. CPC G09G 3/3677; G02F 1/136213; G02F 1/136286; G09G 2320/0209; G02F 1/1368; G02F 2201/123; G09G 2300/0439; G09G 3/3688

(57) ABSTRACT

The present disclosure provides a pixel circuit structure and a display panel. The pixel circuit structure includes data lines, scanning lines defining a pixel region with the data lines, an active switch coupled to the data lines and the scanning lines, a liquid crystal capacitor coupled to the active switch, a first storage capacitor coupled to the active switch, and second storage capacitors coupled to the first storage capacitor.

### TECHNICAL FIELD

The present disclosure relates to the technical field of displays, and particularly relates to a pixel circuit structure and a display panel capable of improving crosstalk.

### BACKGROUND

In recent years, with the progress of science and technology, many different display devices, such as liquid crystal display apparatuses (LCD apparatuses) or electro luminescence (EL) display devices, are widely used in flat panel displays. In taking the LCD apparatuses as an example, most LCD apparatuses are backlight LCD apparatuses, which are composed of liquid crystal display panels and backlight modules. Each liquid crystal display panel is composed of two transparent substrates and a liquid crystal enclosed between the substrates.

In current LCD apparatuses, data signals are generally provided respectively through a plurality of pixel electrodes according to image information, and required images are displayed by controlling light transmittance of a plurality of pixel units. Specifically, each pixel electrode is respectively coupled with data lines and a scanning line. The scanning lines are coupled with the pixel electrodes through a thin film transistor (TFT). The scanning lines are used to control to turn on the TFT, and the data lines charges the pixel electrodes. However, the data lines produces many parasitic capacitances when charging. The parasitic capacitances enable voltage of the pixel electrodes to be shared due to crosstalk, causing abnormal color display because of inadequate voltage of the pixel electrodes. Moreover, as the resolution is higher and higher, the crosstalk is more obvious.

### SUMMARY

A technical problem to be solved by the present disclosure is to provide a pixel circuit structure capable of improving crosstalk. One purpose of the present disclosure is to provide a pixel circuit structure which comprises:

data lines,

scanning lines defining a pixel region with the data lines,

an active switch coupled to the data lines and the scanning lines,

a liquid crystal capacitor coupled to the active switch,

a first storage capacitor coupled to the active switch, and

second storage capacitors coupled to the first storage capacitor and coupled to a direct current voltage.

In some embodiments, a number of the second storage capacitors is at least two.

In some embodiments, a first end of the first storage capacitor is coupled to the active switch, and a second end of the first storage capacitor is coupled to a common line.

In some embodiments, a first end of the first storage capacitor is coupled to the active switch, and a second end of the first storage capacitor is coupled to one of the scanning lines.

In some embodiments, the first storage capacitor and the second storage capacitors are formed by a first conducting layer, a second conducting layer and a third conducting layer. The first conducting layer is coupled with a drain of the active switch. The second conducting layer is coupled with a first voltage line. The third conducting layer is coupled with a second voltage line. The first conducting layer, the second conducting layer and the third conducting layer are stacked and spacedly arranged, and the first conducting layer, the second conducting layer and the third conducting layer are mutually covered in a vertical space.

In some embodiments, the first voltage line comprises a common line.

In some embodiments, the second voltage line and the common line are overlapped within a covering region of the first conducting layer.

In some embodiments, the first voltage line comprises one of the above scanning lines.

In some embodiments, at least one of the first conducting layer, the second conducting layer and the third conducting layer is made of transparent conducting material.

Another purpose of the present disclosure is to provide a pixel circuit structure comprising:

data lines,

scanning lines defining a pixel region with the data lines,

an active switch coupled to the data lines and the scanning lines,

a liquid crystal capacitor coupled to the active switch,

a first storage capacitor coupled to the active switch, where a first end of the first storage capacitor is coupled to the active switch, and a second end of the first storage capacitor is coupled to a common line or one of the scanning lines, and

second storage capacitors coupled to the first storage capacitor and coupled to a direct current voltage.

The first storage capacitor and the second storage capacitors are formed by a first conducting layer, a second conducting layer and a third conducting layer. The first conducting layer is coupled with a drain of the active switch. The second conducting layer is coupled with a first voltage line. The third conducting layer is coupled with a second voltage line. The first conducting layer, the second conducting layer and the third conducting layer are stacked and spacedly arranged, and the first conducting layer, the second conducting layer and the third conducting layer are mutually covered in a vertical space.

A display panel of the present disclosure comprises an array substrate, where the array substrate comprises the pixel circuit structure which comprises:

data lines,

scanning lines defining a pixel region with the data lines,

an active switch coupled to the data lines and the scanning lines,

a liquid crystal capacitor coupled to the active switch,

a first storage capacitor coupled to the active switch, and

second storage capacitors coupled to the first storage capacitor and coupled to a direct current voltage.

Two storage capacitors simultaneously maintain magnitude of the pixel voltage of the pixel structure for reducing the influence of parasitic capacitance, to improve the influence of the crosstalk, so that the display panel can normally show.

### DESCRIPTION OF THE DRAWINGS

The drawings included are used for providing further understanding of embodiments of the present application, constitute part of the description, are used for illustrating implementation manners of the present application, and interpret principles of the present application together with text description. Apparently, the drawings in the following description are merely some embodiments of the present application, and for those of ordinary skill in the art, other drawings can also be obtained according to the drawings without contributing creative labor. In the drawings:

FIG. 1 is a structural schematic diagram of a pixel structure of the present disclosure.

FIG. 2 is a structural schematic diagram of a pixel structure of the present disclosure.

FIG. 3 is a structural schematic diagram of a pixel structure of the present disclosure.

FIG. 4 is a structural schematic diagram of a pixel structure of the present disclosure.

FIG. 5 is a circuit schematic diagram of a pixel structure of the present disclosure.

FIG. 6 is a circuit schematic diagram of a pixel structure of the present disclosure.

FIG. 7 is a circuit schematic diagram of a pixel structure of the present disclosure.

FIG. 8 is a circuit schematic diagram of a pixel structure of the present disclosure.

FIG. 9 is a structural schematic diagram of a pixel structure of an embodiment of the present disclosure.

FIG. 10 is a structural schematic diagram of a pixel structure of an embodiment of the present disclosure.

FIG. 11 is a structural schematic diagram of a pixel structure of an embodiment of the present disclosure.

FIG. 12 is a structural schematic diagram of a pixel structure of an embodiment of the present disclosure.

FIG. 13 is a schematic diagram of a pixel circuit structure of an embodiment of the present disclosure.

FIG. 14 is a schematic diagram of a pixel circuit structure of an embodiment of the present disclosure.

FIG. 15 is a schematic diagram of coordination among a first conducting layer, a second conducting layer and a third conducting layer in an embodiment of the present disclosure.

FIG. 16 is a schematic diagram of cooperation among a first conducting layer, a second conducting layer and a third conducting layer in an embodiment of the present disclosure.

FIG. 17 is an equivalent circuit diagram of a storage capacitor of an embodiment of the present disclosure.

### DETAILED DESCRIPTION

Specific structure and function details disclosed herein are only representative and are used for the purpose of describing exemplary embodiments of the present disclosure. However, the present disclosure may be specifically achieved in many alternative forms and shall not be interpreted to be only limited to the embodiments described herein.

It should be understood in the description of the present disclosure that terms such as “central”, “horizontal”, “upper”, “lower”, “left”, “right”, “vertical”, “horizontal”, “top”, “bottom”, “inner”, “outer”, etc. indicate direction or position relationships shown based on the drawings, and are only intended to facilitate the description of the present disclosure and the simplification of the description rather than to indicate or imply that the indicated device or assembly must have a specific direction or constructed and operated in a specific direction, and therefore, shall not be understood as a limitation to the present disclosure. In addition, the terms such as “first” and “second” are only used for the purpose of description, rather than being understood to indicate or imply relative importance or hint the number of indicated technical features. Thus, the feature limited by “first” and “second” can explicitly or impliedly comprise one or more features. In the description of the present disclosure, the meaning of “a plurality of” is two or more unless otherwise specified. In addition, the term “comprise” and any variant are intended to cover non-exclusive inclusion.

It should be noted in the description of the present disclosure that, unless otherwise specifically regulated and defined, terms such as “installation”, “bonded” and “bonding” shall be understood in broad sense, and for example, may refer to fixed bonding or detachable bonding or integral bonding, may refer to mechanical bonding or electrical bonding, and may refer to direct bonding or indirect bonding through an intermediate medium or inner communication of two assemblies. For those of ordinary skill in the art, the meanings of the above terms in the present disclosure may be understood according to specific conditions.

The terms used herein are intended to merely describe specific embodiments, not to limit the exemplary embodiments. Unless otherwise noted clearly in the context, singular forms “one” and “single” used herein are also intended to comprise plurals. It should also be understood that the terms “comprise” and/or “include” used herein specify the existence of stated features, integers, steps, operation, units and/or assemblies, not excluding the existence or addition of one or more other features, integers, steps, operation, units, assemblies and/or combinations of these.

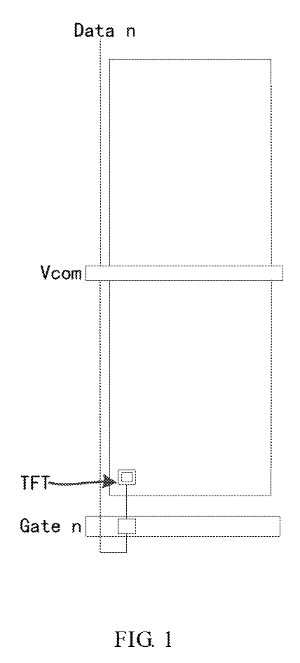

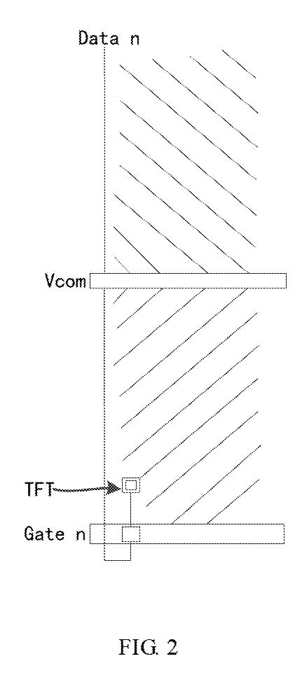

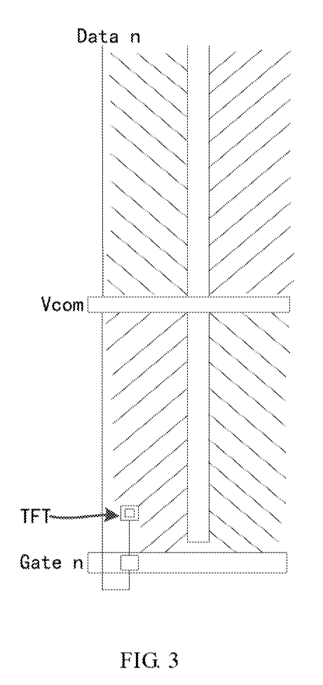

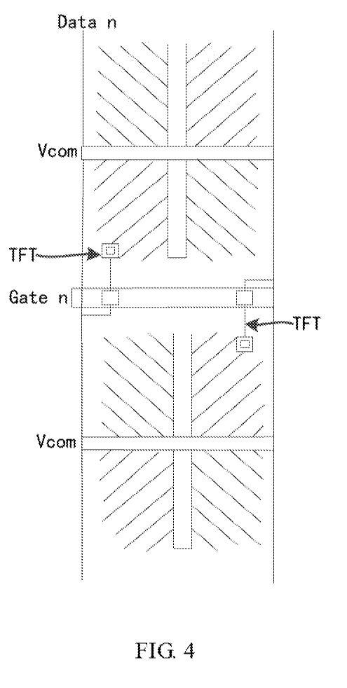

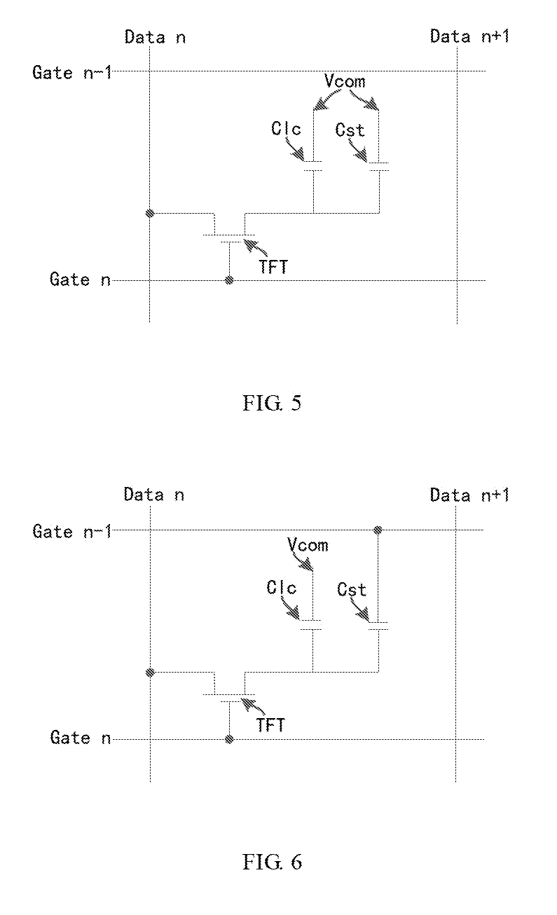

Because the charging time within a single charging time is short, in order to maintain the voltage Vpixel of a pixel structure, as shown in FIG. 1 to FIG. 8, specifically, the pixel structure is respectively coupled with a current data line Data n and a current scanning lines Gate n, and the current scanning lines are coupled with the pixel structure through an active switch TFT (which is an example, but not limited to TFT). The current scanning lines are used for controlling to turn on the active switch TFT, and the current data line Data n charges the pixel structure. The current data line Data n charges a liquid crystal capacitor Clc and a storage capacitor Cst in a process of charging the pixel structure through charging voltage (Vdata), and the pixel structure maintains magnitude of the voltage (Vpixel) of the pixel structure through the storage capacitor Cst so that the display panel can normally show.

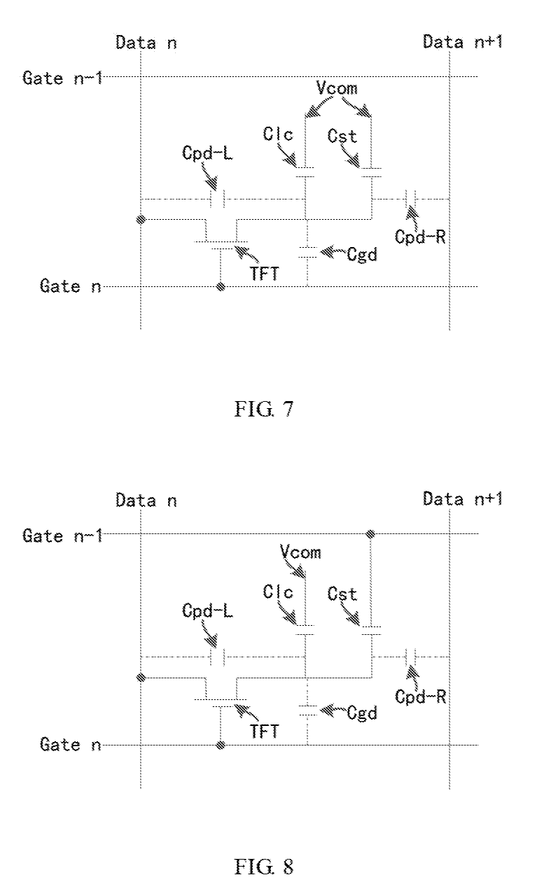

However, in a display process of the display panel, different grey scales are displayed. The voltage of the current data line Data n for charging the pixel structure is changed continuously, so that the voltage of the pixel structure is also changed. Because the charging voltage of the current data line and the pixel structure have many parasitic capacitances (Cpd-L, Cgd and Cpd-R), as shown in dotted portions of FIG. 7 and FIG. 8, the capacitances among the dotted portions are the parasitic capacitances. The parasitic capacitances (Cpd-L, Cgd and Cpd-R) enable the voltage of the pixel structure to be shared due to crosstalk, causing abnormal color display because of inadequate voltage of the pixel structure.

To reduce the influence of the parasitic capacitances and improve the influence of the crosstalk, the applicant further adopts the following two methods:

The first method is that the data lines are arranged away from the pixel structure, so that the generation of the parasitic capacitances is reduced and the influence of the crosstalk becomes smaller. However, a plane space of the display panel is increased, so the first method is unsuitable for use in the display panel with higher resolution.

The second method is that the storage capacitor Cst is increased to be much larger than the parasitic capacitances (Cpd-L, Cgd and Cpd-R), so that the influence of the crosstalk becomes smaller. However, because size of the conducting layer in the storage capacitor is increased, the plane space of the pixel structure is also increased. As the resolution becomes higher and higher, space of the pixel electrode becomes smaller and smaller, causing arrangement of the storage capacitor to be reduced. Thus, increasing the storage capacitor is also unsuitable for higher resolution display panels. Because of limitations of the size of the plane space of the storage capacitor, effectiveness of improving the crosstalk by increasing the storage capacitor is also reduced.

Therefore, the applicant also designs another technical solution for solving the above technical problem, specifically:

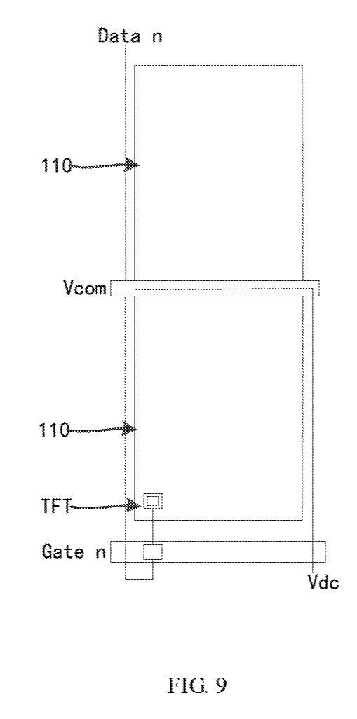

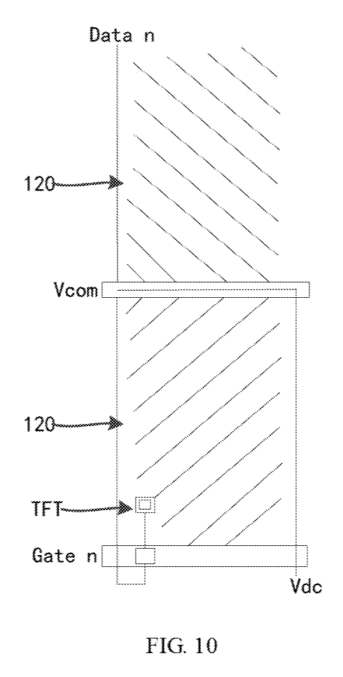

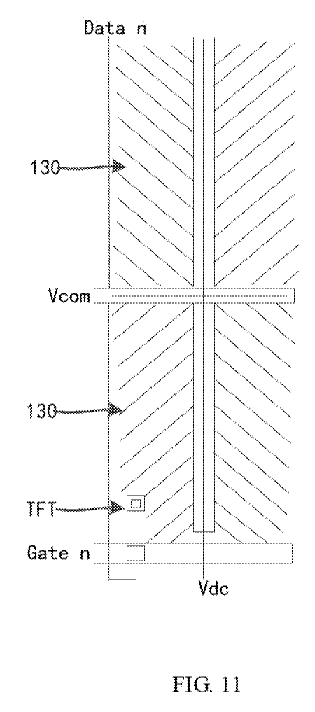

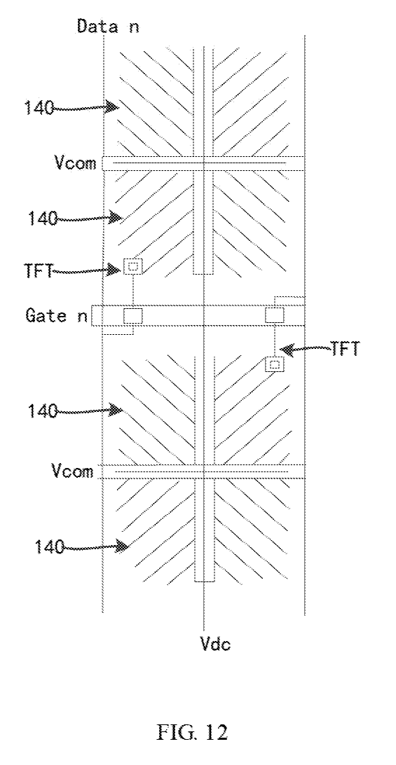

The present disclosure will be further described in detail below in combination with FIG. 9 to FIG. 16 and preferred embodiments.

As shown in FIG. 9 to FIG. 16, an embodiment of the present disclosure discloses a pixel structure and a pixel circuit structure. The present embodiment may include a plurality of pixel structures and pixel circuit structures. A plurality of pixel structures can be respectively used in different display devices. For example, the pixel structures of the present disclosure are used in the following display devices: a twisted nematic (TN) or super twisted nematic (STN) type panel, an in-plane switching (IPS) type panel, a vertical alignment (VA) type panel, a high vertical alignment (HVA) type panel, and a curved surface type panel.

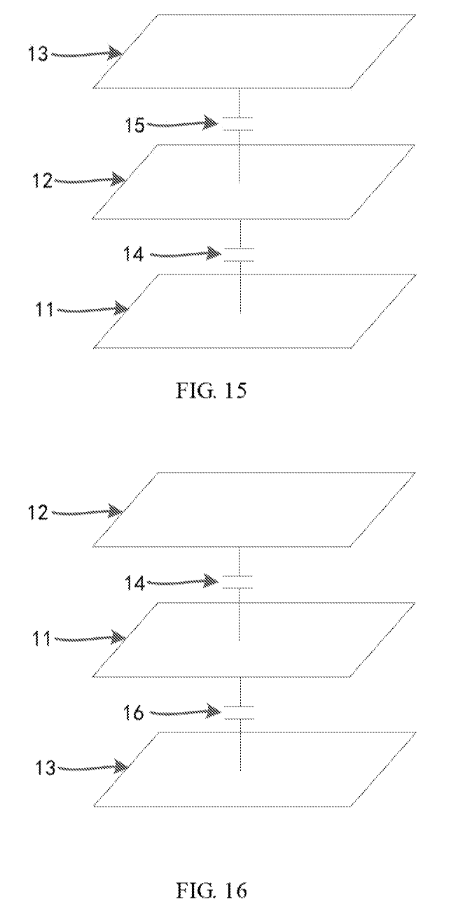

The pixel structure in the embodiment of the present disclosure comprises a first conducting layer 11, a second conducting layer 12 and a third conducting layer 13. As shown in FIG. 15 and FIG. 16, the first conducting layer 11 is coupled with a drain of the active switch TFT (which is an example, but not limited to TFT), the second conducting layer 12 is coupled with a first voltage line, and the third conducting layer 13 is coupled with a second voltage line. The first conducting layer 11, the second conducting layer 12 and the third conducting layer 13 are stacked and spacedly arranged, and the first conducting layer 11, the second conducting layer 12 and the third conducting layer 13 are mutually covered in a vertical space.

Compared with the prior art, three conducting layers of the pixel structure of the embodiment of the present disclosure can be energized to form two storage capacitors. The two storage capacitors simultaneously maintains the magnitude of the pixel voltage of the pixel structure to reduce influence of the parasitic capacitances and improve influence of the crosstalk, so that the display panel can normally show.

In addition, in the embodiment of the present disclosure, magnitude of the voltage of the pixel structure is kept through two storage capacitors. Compared with the pixel structure in FIG. 1 to FIG. 8, magnitude of the voltage of the pixel structure is kept through one storage capacitor, and effect of maintaining magnitude of the voltage of the pixel structure is better so that magnitude of the voltage of the pixel structure is more stable. Meanwhile, in the embodiment of the present disclosure, the first conducting layer, the second conducting layer and the third conducting layer are directly stacked without increasing size of the plane of each conducting layer. Because of this, the embodiment of the present disclosure greatly enhances the capacitance of the pixel structure without increasing size of the plane of each conducting layer, and better keeps magnitude of the voltage of the pixel structure, so that the present disclosure is more suitable for high resolution display panels.

In some embodiments, more stacked conducting layers can also be formed in the pixel structure to form more storage capacitors (a fourth storage capacitor, a fifth storage capacitor, etc) in the pixel structure.

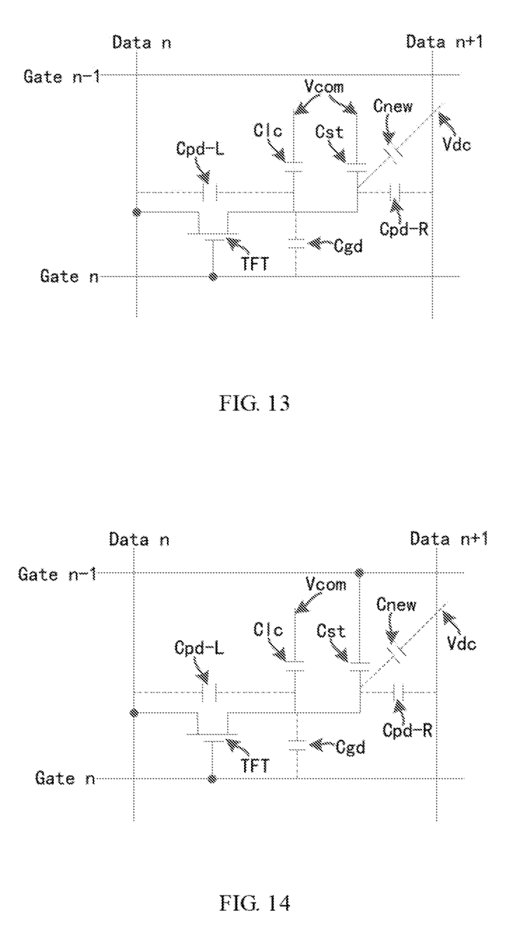

In the present embodiment of the present disclosure, as shown in FIG. 16, FIG. 16 is a specific manner for stacking the first conducting layer, the second conducting layer and the third conducting layer in an embodiment of the present disclosure. Specifically, the first conducting layer 11 is arranged between the second conducting layer 12 and the third conducting layer 13. Because of this, a first storage capacitor 14 is formed between the first conducting layer 11 and the second conducting layer 12. In combination with FIG. 13 and FIG. 14, the first storage capacitor 14 is the storage capacitor Cst. When the structure in FIG. 16 is adopted by the pixel structure, the storage capacitor Cst is defined as the first storage capacitor 14 herein. A second storage capacitor 16 is formed between the first conducting layer and the third conducting layer 13. The second storage capacitor 16 is the storage capacitor Cnew, and the storage capacitor Cnew is defined as the second storage capacitor 16 herein. Thus, two storage capacitors (the first storage capacitor 11 and the second storage capacitor 16) jointly keep the potential of the voltage of the pixel structure, and the voltage of the pixel structure is not influenced due to the change of the charging voltage of the current data line in the charging process, thereby improving phenomenon of the crosstalk.

However, it should be noted that FIG. 16 is only a specific distribution of conducting layer structures in an embodiment of the present disclosure, and other structure distributions can also be made. For example, as shown in FIG. 15, FIG. 16 is another specific manner for stacking the first conducting layer, the second conducting layer and the third conducting layer in an embodiment of the present disclosure. Specifically, the second conducting layer 12 is arranged between the first conducting layer 11 and the third conducting layer 13. Because of this, a same storage capacitor as that in FIG. 16, i.e., the first storage capacitor 14, is formed between the first conducting layer 11 and the second conducting layer 12. Similarly, in combination with FIG. 13 and FIG. 14, the first storage capacitor 14 is the storage capacitor Cst, and the storage capacitor Cst is defined herein as the first storage capacitor 14. A third storage capacitor 15 is formed between the second conducting layer 12 and the third conducting layer 13. Similarly, in combination with FIG. 13 and FIG. 14, the third storage capacitor 15 is also shown as the storage capacitor Cnew (but it should be noted that because only one new storage capacitor, i.e., the second storage capacitor or the third storage capacitor, can be shown in FIG. 13 and FIG. 14, Cnew in FIG. 13 and FIG. 14 are only intended to illustrate the second storage capacitor or the third storage capacitor. Herein, the second storage capacitor and the third storage capacitor are not the same.). Herein, when the structure in FIG. 15 is adopted by the pixel structure, the storage capacitor Cnew is defined herein as the third storage capacitor 15. Thus, two storage capacitors (the first storage capacitor and the third storage capacitor) jointly keep the potential of the voltage of the pixel structure, and the voltage of the pixel structure is not influenced due to the change of the charging voltage of the current data line in the charging process, thereby improving phenomenon of the crosstalk.

In the following description, the second storage capacitor or the third storage capacitor is replaced by Cnew in the present embodiment.

As shown in FIG. 13 and FIG. 14, the first conducting layer 11 is coupled with the drain of the active switch TFT. A first end of the capacitor Clc is coupled with a common line Vcom. The capacitor Clc is coupled with the active switch TFT. The thin film transistor is respectively coupled with the current data line Data n and the current scanning lines Gate n. When the current scanning lines controls to turn on the thin film transistor, the current data line charges the pixel structure through the thin film transistor, and specifically charges the liquid crystal capacitor Clc and two storage capacitors (Cst and Cnew. Specifically in FIG. 16, the first storage capacitor and the second storage capacitor, or specifically in FIG. 15, the first storage capacitor and the third storage capacitor).

Further, the first voltage line comprises a previous scanning lines Gate n−1. As shown in FIG. 14, namely, the second conducting layer 12 is coupled with the previous scanning line. The charging process of the pixel structure is that the active switch TFT is controlled to conduct through the current scanning lines Gate n, so that the current data line Data n charges the pixel structure. However, the previous scanning lines are on the previous row of the current scanning line. The second conducting layer 12 is charged in advance through the previous scanning lines, so that the second conducting layer 12 has voltage. When the current data line is used for charging, charging time can be reduced and the second conducting layer 12 can quickly reach a predetermined potential. This is a specific manner for coupling the second conducting layer and the first voltage line. Of course, it should be noted that the second conducting layer can also be coupled to other first voltage lines. For example, as shown in FIG. 13, the first voltage line comprises a common line Vcom. Namely, the second conducting layer 12 is coupled with the common line Vcom. The common line Vcom charges the second conducting layer. This manner is simple in structure.

In an embodiment of the present disclosure, the third conducting layer 13 is coupled with the second voltage line. As shown in FIG. 9 to FIG. 14, the second voltage line Vdc in an embodiment of the present disclosure is coupled to a direct current voltage. A voltage range of the common line connected with the second conducting layer is, for example, 7.5V or 0V. The voltage of the data lines is −5 to 15V. The voltage of the scanning lines is −6 to 35V. Because the third conducting layer connected with the second voltage line has a voltage different from those of and the first conducting layer and the second conducting layer, the storage capacitor is formed between the third conducting layer and the first conducting layer or the second conducting layer.

In the embodiment of the present disclosure, as shown in FIG. 13 and FIG. 14, the pixel circuit structure in the present disclosure comprises:

data lines Data,

scanning lines Gate defining a pixel region with the data lines Data,

an active switch TFT coupled to the data lines Data and the scanning lines Gate,

a liquid crystal capacitor Clc coupled to the active switch TFT,

a first storage capacitor Cst coupled to the active switch TFT, and

second storage capacitors Cnew coupled to the first storage capacitor Cst and coupled to a direct current (direct current) voltage Vdc.

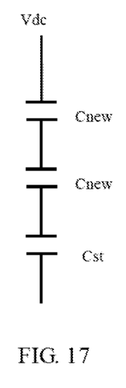

As shown in FIG. 17, in some embodiments, the pixel circuit structure of the present disclosure can comprise at least two second storage capacitors Cnew coupled between the first storage capacitor Cst and the direct current voltage Vdc to further improve influence of the crosstalk.

In some embodiments, a first end of the first storage capacitor Cst is coupled to the active switch TFT, and a second end of the first storage capacitor Cst is coupled to a common line Vcom, as shown in FIG. 13.

In some embodiments, a first end of the first storage capacitor Cst is coupled to the active switch TFT, and a second end of the first storage capacitor Cst is coupled to one (the previous scanning lines Gate n−1) of the scanning lines Gate, as shown in FIG. 14.

In some embodiments, the first storage capacitor Cst and the second storage capacitors Cnew are formed by a first conducting layer, a second conducting layer and a third conducting layer. The first conducting layer is coupled with a drain of the active switch. The second conducting layer is coupled with a first voltage line. The third conducting layer is coupled with a second voltage line. The first conducting layer, the second conducting layer and the third conducting layer are stacked and spacedly arranged, and the first conducting layer, the second conducting layer and the third conducting layer are mutually covered in a vertical space.

In some embodiments, the first voltage line comprises a common line Vcom.

In some embodiments, the second voltage line and the common line Vcom are overlapped within a covering region of the first conducting layer.

In some embodiments, the first voltage line comprises one of the above scanning lines, Gate n−1.

In an embodiment of the present disclosure, the first conducting layer 11, the second conducting layer 12 and the third conducting layer 13 are respectively made of conductive metal. This is a specific structure of arranging the first conducting layer, the second conducting layer and the third conducting layer in the present disclosure. Three conducting layers (the first conducting layer 11, the second conducting layer 12 and the third conducting layer 13) are made of conductive metal, and the conductive metal has good conduction, where the conductive metal in an embodiment of the present disclosure may be: Al, Mo, Cu, Ti, Ag, or alloys thereof.

It should be noted that it is a specific manner in the embodiment of the present disclosure that three conducting layers (the first conducting layer 11, the second conducting layer 12 and the third conducting layer 13) are made of conductive metal or other conducting materials, and other manners can also be adopted in the embodiment of the present disclosure.

### Example 1

The first conducting layer 11 and the second conducting layer 12 are respectively made of conductive metal, and the third conducting layer 13 is made of transparent conducting material. This is another specific structure of arranging the first conducting layer 11, the second conducting layer 12 and the third conducting layer 13 in the embodiment of the present disclosure. The first conducting layer 11 and the second conducting layer 12 are made of conductive metal, and the conductive metal has a good conduction. The third conducting layer 13 is made of transparent conductive material, and can also realize the conduction. The transparent conducting material includes, for example, ITO, IZO, AZO, ATO, GZO, TCO, ZnO, or PEDOT.

### Example 2

The first conducting layer 11 is made of conductive metal, and the second conducting layer 12 and the third conducting layer 13 are respectively made of transparent conductive material. This is another specific structure of arranging the first conducting layer 11, the second conducting layer 12 and the third conducting layer 13 in the embodiment of the present disclosure. The first conducting layer 11 is made of conductive metal, and the conductive metal has good conduction. The second conducting layer 12 and the third conducting layer 13 are made of transparent conductive material, and can also realize conduction.

In an embodiment of the present disclosure, as shown in FIG. 9 to FIG. 12, the second voltage line Vdc and the common line Vcom are partially overlapped in space. Specifically, the second voltage line and the common line are overlapped within a covering region of the first conducting layer. If at least two conducting wires are arranged in parallel, parasitic capacitance may also be produced among the conducting wires to cause mutual interference. However, in the embodiment of the present disclosure, the common line Vcom and the second voltage line Vdc are partially overlapped in space to avoid producing the parasitic capacitance, thereby enhancing anti-interference capability.

Moreover, three conducting layers (the first conducting layer 11, the second conducting layer 12 and the third conducting layer 13) in an embodiment of the present disclosure are parallel to each other. Thus, three conducting layers occupy a smaller space in a plane space, so that the effect of using the pixel structure in the embodiment of the present disclosure to the display panel is better.

In another embodiment of the present disclosure, the embodiment of the present disclosure further discloses an array substrate. The common line, the data lines and the scanning lines are arranged on the array substrate. The array substrate also comprises a pixel structure which is respectively coupled with the data lines and the scanning lines, where for the common line, the data lines, the scanning lines and the pixel structure on the array substrate in the present embodiment, see the common line, the data lines, the scanning lines and the pixel structure in the above embodiment. Alternatively, for the common line, the data lines, the scanning lines and the pixel structure on the array substrate in the present embodiment, see the common line, the data lines, the scanning lines, the pixel structure and mutual coordination and connection in FIG. 9 to FIG. 16. The array substrate in the present embodiment has a plurality of pixel structures. For each pixel structure, see FIG. 9 to FIG. 16. The pixel structure, the common line, the data lines, the scanning lines, etc. are not described herein in detail.

In another embodiment of the present disclosure, the embodiment of the present disclosure further discloses a display panel. The display panel comprises a color film substrate and an array substrate. The common line, the data lines and the scanning lines are arranged on the array substrate. The array substrate also comprises a pixel structure which is respectively coupled with the data lines and the scanning lines, where for the common line, the data lines, the scanning lines and the pixel structure in the display panel in the present embodiment, see the common line, the data lines, the scanning lines and the pixel structure in the above embodiment. Alternatively, for the common line, the data lines, the scanning lines and the pixel structure in the display panel in the present embodiment, see the common line, the data lines, the scanning lines, the pixel structure and mutual coordination and connection in FIG. 9 to FIG. 16. The array substrate in the present embodiment has a plurality of pixel structures. For each pixel structure, see FIG. 9 to FIG. 16. The pixel structure, the common line, the data lines, the scanning lines, etc. are not described herein in detail.

In another embodiment of the present disclosure, the embodiment of the present disclosure further discloses a display device. The display device comprises a display panel and a backlight module, where the display panel comprises a color film substrate and an array substrate. The common line, the data lines and the scanning lines are arranged on the array substrate. The array substrate also comprises a pixel structure which is respectively coupled with the data lines and the scanning lines, where for the common line, the data lines, the scanning lines and the pixel structure in the display panel in the present embodiment, see the common line, the data lines, the scanning lines and the pixel structure in the above embodiment. Alternatively, for the common line, the data lines, the scanning lines and the pixel structure in the display panel in the present embodiment, see the common line, the data lines, the scanning lines, the pixel structure and mutual coordination and connection in FIG. 9 to FIG. 16. The array substrate in the present embodiment has a plurality of pixel structures. For each pixel structure, see FIG. 9 to FIG. 16. The pixel structure, the common line, the data lines, the scanning lines, etc. are not described herein in detail. The display device in the present embodiment may be a liquid crystal display or other display devices. When the display device is the liquid crystal display, the backlight module may be used as a light source used for supplying sufficient brightness and uniformly distributed light sources. The backlight module in the present embodiment may be a front-light type, or a backlight type. It should be noted that the backlight module in the present embodiment is not limited thereto.

The above contents are further detailed descriptions of the present disclosure in combination with specific preferred embodiments. However, the specific implementation of the present disclosure shall not be considered to be only limited to these descriptions. For those of ordinary skill in the art to which the present disclosure belongs, several simple deductions or replacements may be made without departing from the conception of the present disclosure, all of which shall be considered to belong to the protection scope of the present disclosure.

1. A pixel circuit structure, comprising:
data lines;
scanning lines defining a pixel region with the data lines;
an active switch coupled to the data lines and the scanning lines;
a liquid crystal capacitor coupled to the active switch;
a first storage capacitor coupled to the active switch; and
second storage capacitors coupled to the first storage capacitor and coupled to a Direct current (DC) voltage.

2. The pixel circuit structure according to claim 1, wherein a first end of the first storage capacitor is coupled to the active switch, and a second end of the first storage capacitor is coupled to a common line.

3. The pixel circuit structure according to claim 1, wherein a first end of the first storage capacitor is coupled to the active switch, and a second end of the first storage capacitor is coupled to one of the scanning lines.

4. The pixel circuit structure according to claim 1, wherein the first storage capacitor and the second storage capacitors are formed by a first conducting layer, a second conducting layer, and a third conducting layer; the first conducting layer is coupled with a drain of the active switch; the second conducting layer is coupled with a first voltage line; the third conducting layer is coupled with a second voltage line; the first conducting layer, the second conducting layer and the third conducting layer are stacked and spacedly arranged; and the first conducting layer, the second conducting layer and the third conducting layer are mutually covered in a vertical space.

5. The pixel circuit structure according to claim 4, wherein the first voltage line comprises a common line.

6. The pixel circuit structure according to claim 4, wherein the second voltage line and the common line overlap within a covering region of the first conducting layer.

7. The pixel circuit structure according to claim 4, where the first voltage line comprises one scanning line.

8. The pixel circuit structure according to claim 4, wherein at least one of the first conducting layer, the second conducting layer, and the third conducting layer is made of transparent conducting material.

9. The pixel circuit structure according to claim 1, wherein a number of the second storage capacitors is at least two.

10. A pixel circuit structure, comprising:
data lines;
scanning lines defining a pixel region with the data lines;
an active switch coupled to the data lines and the scanning lines;
a liquid crystal capacitor coupled to the active switch;
a first storage capacitor coupled to the active switch, where a first end of the first storage capacitor is coupled to the active switch, and a second end of the first storage capacitor is coupled to a common line or one of the scanning lines; and
second storage capacitors coupled to the first storage capacitor and coupled to a direct current voltage,
wherein the first storage capacitor and the second storage capacitors are formed by a first conducting layer, a second conducting layer and a third conducting layer; the first conducting layer is coupled with a drain of the active switch; the second conducting layer is coupled with a first voltage line; the third conducting layer is coupled with a second voltage line; the first conducting layer, the second conducting layer and the third conducting layer are stacked and spacedly arranged; and the first conducting layer, the second conducting layer and the third conducting layer are mutually covered in a vertical space,
wherein a number of the second storage capacitors is at least two.

11. A display panel, comprising an array substrate, wherein the array substrate comprises a pixel circuit structure which comprises:
data lines;
scanning lines defining a pixel region with the data lines;
an active switch coupled to the data lines and the scanning lines;
a liquid crystal capacitor coupled to the active switch;
a first storage capacitor coupled to the active switch; and
second storage capacitors coupled to the first storage capacitor and coupled to a direct current voltage.

12. The display panel according to claim 11, wherein a first end of the first storage capacitor is coupled to the active switch, and a second end of the first storage capacitor is coupled to a common line.

13. The display panel according to claim 11, wherein a first end of the first storage capacitor is coupled to the active switch, and a second end of the first storage capacitor is coupled to one of the scanning lines.

14. The display panel according to claim 11, wherein the first storage capacitor and the second storage capacitors are formed by a first conducting layer, a second conducting layer and a third conducting layer; the first conducting layer is coupled with a drain of the active switch; the second conducting layer is coupled with a first voltage line; the third conducting layer is coupled with a second voltage line; the first conducting layer, the second conducting layer and the third conducting layer are stacked and spacedly arranged; and the first conducting layer, the second conducting layer and the third conducting layer are mutually covered in a vertical space.

15. The display panel according to claim 14, wherein the first voltage line comprises a common line.

16. The display panel according to claim 14, wherein the second voltage line and the common line are overlapped within a covering region of the first conducting layer.

17. The display panel according to claim 14, where the first voltage line comprises one of the above scanning lines.

18. The display panel according to claim 14, wherein at least one of the first conducting layer, the second conducting layer, and the third conducting layer is made of transparent conducting material.

19. The display panel according to claim 11, wherein a number of the second storage capacitors is at least two.
